(19) United States
(12) Patent Application Publication
(10) Pub. No.: US 2021/0370194 A1
(43) Pub. Date: Dec. 2, 2021

(54) APPARATUS INTEGRATING A ZOETROPE INTO AN INFLATABLE BALL OR SYMMETRICAL TRANSPARENT OBJECT

(71) Applicant: Gary Kemp, San Antonio, TX (US)

(72) Inventor: Gary Kemp, San Antonio, TX (US)

(21) Appl. No.: 17/400,061

(22) Filed: Aug. 11, 2021

Related U.S. Application Data
(63) Continuation-in-part of application No. 29/734,319, filed on May 11, 2020.

(51) Int. Cl. A63H 33/22; A63B 41/00; A63B 43/00

(52) U.S. Cl. CPC A63H 33/22; A63B 41/00; A63B 2225/62; A63B 43/005; A63B 43/008

(57) ABSTRACT

An apparatus integrating a zoetrope including a panel made of a transparent material and strips made of an opaque material that attach to the panel at equal distance from one another. The strips include a series of graduated images at the inner side of the panel. The series of images differ slightly and progressively from one to the next. The transparent panel and the strips present a zoetrope in which the transparent panel acts as slits allowing a user to view the images on the strips at the inner side of the panel, and the strips act as a series of segments obscuring the view of the inner side of the panel. The user rotates the panel at an appropriate speed to view the images alternatively through the transparent panel and obscure the images by the strips in rapid succession creating the perception of an animation of the images.

### CROSS-REFERENCE TO RELATED APPLICATIONS

This application claims priority to U.S. Design application Ser. No. 29/734,319, filed on May 11, 2020, titled “INFLATABLE ZEOTROPE BALL DESIGN,” Attorney Docket No. KEMPOOlUSD, which is here incorporated by reference in its entirety.

### FIELD OF INVENTION

The present invention generally relates to animated amusement devices. More specifically, the present invention relates to an apparatus integrating a zoetrope for providing an animated image for a viewer or user, the apparatus including an inflatable ball, a beverage bottle and the like.

### BACKGROUND OF INVENTION

A zoetrope is a device that presents a perception of animation by successively revealing and obscuring a sequential series of individual and still images in relation to a viewer. Typically, the zoetrope includes a cylindrical wall having a series of slits around its circumference. The slits are equally spaced throughout the circumference of the cylindrical wall. Further, the cylindrical wall includes an inner surface. The inner surface presents a series of individual images. Here, each image positions incrementally or sequentially relative to the last or previous image. Alternatively, the inner surface includes a strip made of a paper or any other suitable material. The strip includes a series of individual images, in which each image positions incrementally or sequentially relative to the last image. Here, the series of individual images at the inner surface come or position in parallel to the series of slits at the outer side of the cylindrical wall. When the zoetrope rotates around its axis, the viewer views the inner surface alternatively through the slits and gets obscured by the portion/segment adjacent to the slits. At an appropriate speed, the rotation of the zoetrope reveals and obscures the series of individual images positioned at the inner surface in succession. This creates a perception of animation of the images.

Several devices for animating a sequence of inanimate objects have been disclosed in the past. For example, a zoetrope utilizing a light source to rapidly illuminate and obscure images and/or three-dimensional (3D) characters when rotated around a central axis is also disclosed. One such example is disclosed in a U.S. granted Pat. No. 9,170,479, entitled, “Zoetrope light emitting device” (“the '479 Patent”). The '479 Patent discloses a zoetrope device having a plurality of panels. Each of the panels is formed with one or more indicia representing various objects such as people and things. The panels are mounted to a rotatable platform that traverses the panels over a light source. When the panel is traversed over the light source, the light source illuminates the edge of the panel and the indicia formed on the panel. The indicia are formed at different depths to provide the viewer with an image that appears to be three dimensional. Moreover, the light source has one or more different light colors for illuminating the indicia therewith and/or alternately illuminating the indicia with different light colors.

Another example is disclosed in a United Kingdom Patent Publication No. 2,493,168 (GB2,493,168), entitled “Activity wheel assembly” (“the '168 Publication”). The '168 Publication discloses an activity wheel, which takes the form of a hamster wheel, that incorporates a zoetrope, comprises a wheel and support means rotatably supporting the wheel. Retaining means retain a series of progressively changing representations in fixed relationship with the wheel so as to rotate therewith. Stroboscope means, causes each of the representations to be presented to a viewer in succession so that the viewer perceives an animated image constituted by the representations. The wheel may alternatively be a treadmill. The treadmill and zoetrope may be linked so that operation of the treadmill causes the zoetrope to operate.

Yet another example is disclosed in a PCT Publication No. 2019122796, entitled “Apparatus for providing an animated image for a viewer” (“the '796 Publication”). The '796 Publication discloses an apparatus for providing an animated image for a viewer, which apparatus comprises: a device for providing the animated image; and securing means for securing the apparatus to a part of a structure such that the apparatus is fixed with respect to the structure, and such that the device is operable by the viewer in order for the viewer to see the animated image.

Although the above-discussed apparatuses present different ways to provide an animated image for a viewer using a zoetrope, none of them disclose a spherical apparatus such as a ball integrating a zoetrope.

Therefore, there is a need in the art to provide an apparatus that comes in a spherical shape such as an airtight inflatable ball integrating a zoetrope.

### SUMMARY

It is an object of the present invention to provide an apparatus integrating a zoetrope and that avoids the drawbacks of known apparatuses.

It is another object of the present invention to provide a spherical (e.g., ball) or cylindrical (e.g., bottle) rotating apparatus providing the illusion of changing imagery.

It is another object of the present invention to provide a zoetrope integrated into an inflatable ball, such as a beach ball.

It is another object of the present invention to provide a zoetrope integrated into an inflatable ball, such as a beach ball, for example. The beach ball is formed such that transparent slits are formed in the beach ball (i.e., the slits are made of transparent material, thus maintaining the airtight nature of the ball), allowing a view into the interior of the ball, where changing illustrations are imprinted. Rotation of the ball allows for viewing through the slits of the changing illustrations, creating the illusion of animated motion.

In order to achieve one or more objects, the present invention provides an apparatus integrating a zoetrope. The apparatus includes a panel made of a transparent material. The apparatus includes a single panel or two or more panels, each having the same shape and size. In one example, the panel(s) takes the shape of an inflatable ball such as a beach ball. In another example, the panel takes the form of a beverage bottle and the like.

The apparatus includes strips attached to the panel. The strips come in a vertical configuration and attach vertically at equal distance from one another. The strips are made of an opaque material. The strips include a series of graduated images at the inner side of the panel. The series of images on the strips differ slightly and progressively from one to the next.

The transparent panel and the strips present a zoetrope in which the transparent panel acts as vertically-extending slits allowing a user to view the images on the strips at the inner side of the panel. Here, the slits extend vertically with respect to the ground on the transparent panels. In other words, the slits extend vertically on the transparent panel when the apparatus rotates in the horizontal plane or rotates about the vertical axis. Further, the strips act as a series of segments obscuring the view of the inner side of the panels. The user rotates the panel at an appropriate speed to view the images alternatively through the transparent panel and obscure the images by the strips in rapid succession creating the perception of an animation of the images.

In one advantageous feature of the present invention, the apparatus provides an airtight inflatable ball incorporating the zoetrope. The transparent panel and the strips present a zoetrope allowing a view into the interior of the ball, where changing illustrations are imprinted. Upon rotating, the ball allows for viewing through the slits of the changing illustrations, creating the illusion of animated motion.

In another advantageous feature of the present invention, the apparatus provides a transparent beverage bottle and the like integrating a zoetrope. Here, the outer body of the beverage bottle acts as the panel. The transparent bottle body and the strips present a zoetrope allowing a view into the interior of the bottle, where changing illustrations are imprinted. Upon rotating, the bottle allows for viewing through the slits of the changing illustrations, creating the illusion of animated motion.

Features and advantages of the subject matter hereof will become more apparent in light of the following detailed description of selected embodiments, as illustrated in the accompanying FIGURES. As will be realised, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present subject matter will become apparent from the following detailed description, taken in combination with the appended drawings, in which:

FIG. 1 illustrates a perspective view of an apparatus integrating a zoetrope, in accordance with one embodiment of the present invention;

FIG. 2 illustrates an exploded view of the apparatus;

FIGS. 3, 4 and 5 illustrate a side perspective view, a front view and a rear view, respectively of a panel of the apparatus, in accordance with one embodiment of the present invention;

FIGS. 6, 7 and 8 illustrate a front, a top and a bottom view, respectively of the apparatus, in accordance with one embodiment of the present invention;

FIGS. 9 and 10 illustrate side perspective views of an apparatus integrating a zoetrope, in accordance with another embodiment of the present invention;

FIGS. 11, and 12 illustrate side views of the apparatus; and

FIGS. 13 and 14 illustrate a front and a top view, respectively of the apparatus.

It will be noted that throughout the appended drawings, like features are identified by like reference numerals.

### DETAILED DESCRIPTION OF THE EMBODIMENTS

Before the present features and working principle of an apparatus is described, it is to be understood that this subject matter is not limited to the particular apparatus as described, since it may vary within the specification indicated. Various features of an apparatus might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present invention describes an apparatus integrating a zoetrope. The apparatus includes a panel made of a transparent material. The apparatus includes strips that attach to the panel vertically at equal distance from one another. The strips are made of an opaque material. The strips include a series of graduated images at the inner side of the panel. The series of images differ slightly and progressively from one to the next. The transparent panel and the strips present a zoetrope in which the transparent panel acts as slits allowing a user to view the images on the strips at the inner side of the panel, and the strips act as a series of segments obscuring the view of the inner side of the panel. The user rotates the panel at an appropriate speed to view the images alternatively through the transparent panel and obscure the images by the strips in rapid succession creating the perception of an animation of the images.

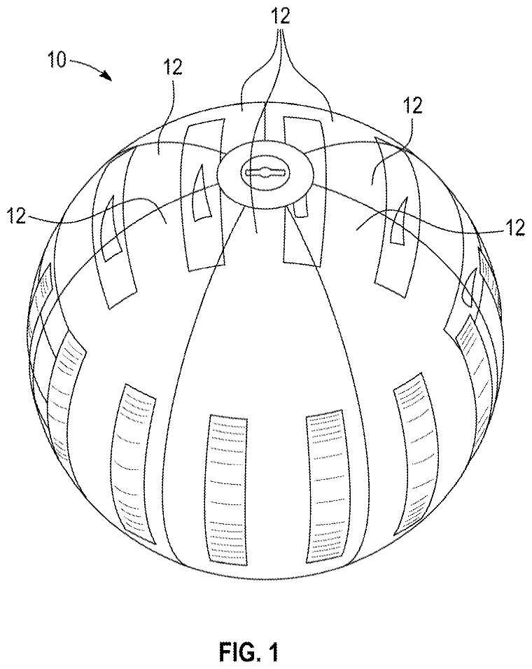

Various features and embodiments of an apparatus integrating a zoetrope are explained in conjunction with the description of FIGS. 1-14.

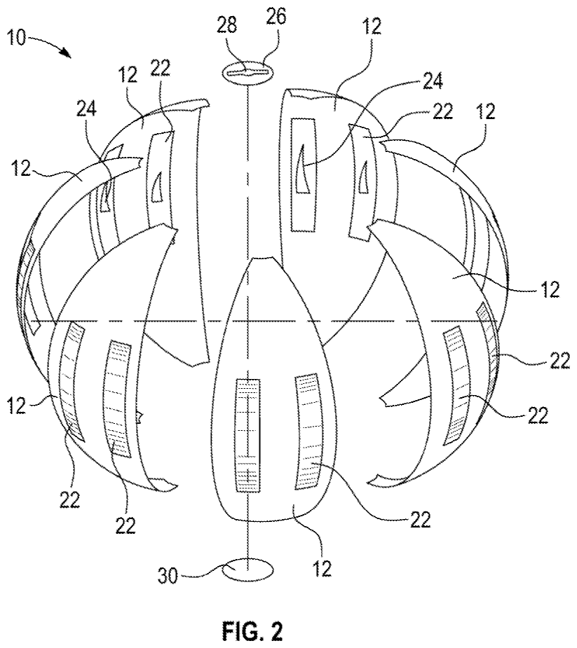

The present invention discloses an apparatus integrating a zoetrope for providing an animated image for a viewer or user. FIG. 1 shows a perspective view of an apparatus 10 integrating a zoetrope, in accordance with one embodiment of the present invention. FIG. 2 shows an exploded view of apparatus 10. As can be seen, apparatus 10 includes a plurality of panels 12. In one example, apparatus 10 includes seven panels 12, each having the same shape and size. In another example, apparatus 10 includes six panels 12, each having the same shape and size. A person skilled in the art understands apparatus 10 can include a single spherical panel 12 or two hemispherical panels 12 or any number of panels in which each panel has the same shape and size to that of others without departing from the scope of the present invention. It is preferable to have an odd number of panels 12, say five, seven or nine panels 12 to create an enhanced perception of the animation of the images. The present embodiment is explained considering that apparatus 10 includes seven panels 12. However, it is obvious to a person skilled in the art to select any number of odd or even number of panels 12 depending on the need. Further, a person skilled in the art understands that such implementations fall within the scope of the present invention.

Panels 12 provide a material made of soft plastic and thin walled material, such as poly-vinyl chloride resin, for example. In accordance with the present invention, panels 12 are made of a transparent material. Each panel 12 is curved such that when plurality of panels 12 are attached, they form an inflatable ball such as a beach ball or balloon, for example as shown in FIG. 1.

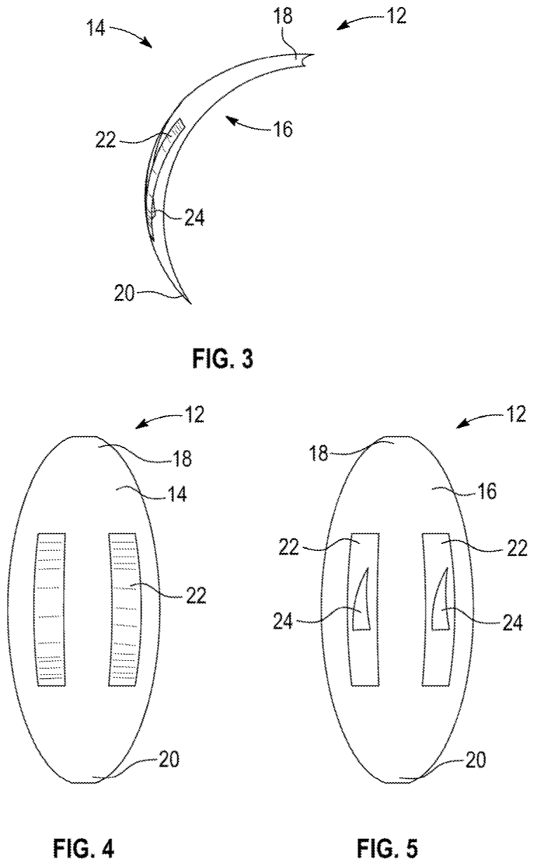

FIGS. 3, 4 and 5 show a side perspective view, a front view and a rear view, respectively of panel 12, in accordance with one embodiment of the present invention. Panel 12 includes first side 14 and second side 16. First side 14 indicates an outer side of panel 12 and second side 16 indicates an inner side of panel 12. Panel 12 includes top 18 and bottom 20. Apparatus 10 includes strips 22. Strips 22 provide a material made of paper, plastic or any other suitable material. Further, strips 22 provide an opaque material and obscure view through them. In one example, strips 22 come in rectangular configuration. In one example, strips 22 attach to panel 12 at first side 14. In another example, strips 22 attach to panel 12 at second side 16. Strips 22 attach to panel 12 using adhesive or fuse seams or stitches or any other known mechanism. Here, strips 22 attach at equal distance from one another, as seen in at least FIGS. 1, 4, 5, 6, 7 and 8. When attached to panel 12, strips 22 obscure the view of a user from first side 14 (FIG. 4). At second side 16, each strip 22 includes a still image 24, as shown in FIG. 5. A person skilled in the art understands that each strip 22 attached to seven panels 12 includes image 24. As such, panels 12 at its inner side i.e., second side 16 include a series of images 24 disposed at strips 22. The user selects images 24 of objects, including but not limited to people, things, scenario images, etc. Each image 24 positions incrementally relative to the last image 24 in any given direction. In other words, strips 22 include a series of graduated images 24 i.e., adjacent images 24 that differ slightly and progressively from one to the next. In one exemplary implementation, images 24 are color coded to present a visually appealing apparatus 10. Although it is presented that strips 22 having images 24 attach to panels 12, it is possible to manufacture panels 12 imprinted or covered with a label having images 24 without departing from the scope of the present invention.

Further, apparatus 10 includes top connecting member 26, as shown in FIGS. 2, 6 and 7. Top connecting member 26 comes in a circular shape and connects to panels 12 at the top 18. Top connecting member 26 includes valve 28. Further, apparatus 10 includes bottom connecting member 30, as shown in FIGS. 2, 6 and 8. Bottom connecting member 30 comes in a circular shape and connects to panels 12 at the bottom 20. Panels 12, top connecting member 26 and bottom connecting member 30 form a ball or spherical shape. Although it is shown that apparatus 10 includes panels 12, top connecting member 26 and bottom connecting member 30 forming a sphere, it is possible to form the sphere with panels 12 (having valve 28) only without the need for top connecting member 26 and bottom connecting member 30.

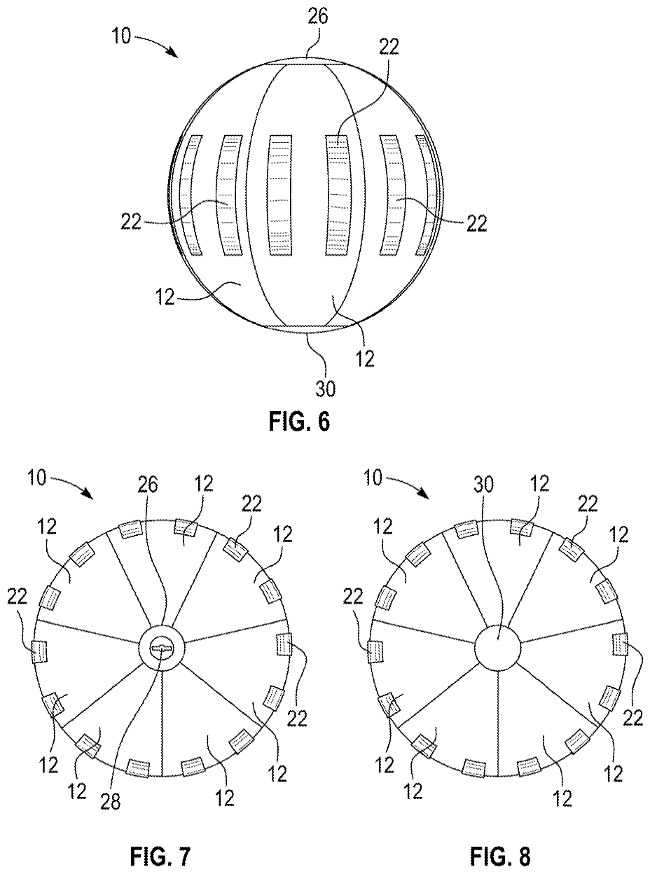

Panels 12, top connecting member 26 and bottom connecting member 30 attach using adhesive, fuse seam or any other known mechanism. Valve 28 allows to inflate apparatus 10 (ball) using a mouth or a pump as known in the art. When inflated, panels 12, top connecting member 26 and bottom connecting member 30 form an inflatable ball that is airtight and provides a ball that rolls easily along a smooth surface. FIGS. 6, 7 and 8 show a front, a top and a bottom view, respectively of apparatus 10 (i.e., inflatable ball), in accordance with one embodiment of the present invention.

Referring now to FIG. 1, operational features of apparatus 10 are explained. As specified above, panels 12, top connecting member 26 and bottom connecting member 30 form an inflatable ball. The user inflates apparatus 10 by blowing the air through the mouth or using a pump. Once inflated, apparatus 10 gives a soft, and bouncy feel. The transparent panels 12 and strips 22 present a zoetrope. Specifically, transparent panels 12 act as viewing slits (i.e., vertically-extending slits beside strips 22) allowing the user to view second side 16 (interior surface/inner side of panel 12). Strips 22 act as segments that obscure the view of the user into the second side 16 (inner side of panel). In other words, panels 12 act as an outer wall of the zoetrope in which strips 22 form a series of segments obscuring the inside view while the gap between strips 22 caused by transparency of panels 12 create see-through/viewing slits of the zoetrope.

The user rotates apparatus 10 and looks at images 24 on strips 22 at second side 16 through transparent panels 12 acting as viewing slits from first side 14. Here, the user views images 24 alternatively through transparent panels 12 and gets obscured by strips 22 between consecutive transparent panels 12. When apparatus 10 rotates or spins at an appropriate speed, images 24 are revealed and obscured in rapid succession to the user thereby creating the perception of an animation of images 24 to the user. When images 24 position incrementally relative to the last images 24, a flickering effect (such as a flip book having different images that perceives an animation) is created to the user.

Based on the above, a person skilled in the art understands that apparatus 10 having transparent panels 12 and strips 22 with images 24 at the inner wall present an inflatable ball integrating a zoetrope.

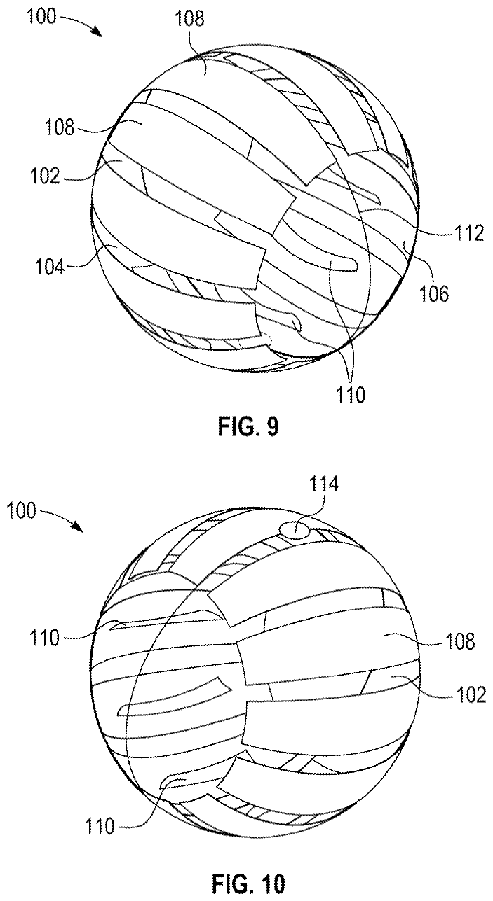

FIGS. 9 and 10 show side perspective views of an apparatus 100 integrating a zoetrope, in accordance with another embodiment of the present invention. Apparatus 100 comes in the shape of a sphere/ball. Apparatus 100 includes panels 102. Here, apparatus 100 includes two panels 102, each having the same (hollow hemispherical) shape and size. In other words, each panel 102 comes in a hemispherical shape and when attached together form a complete sphere. Panels 102 attach at center 112 using adhesive or fuse seams or stitches or any other known mechanism. A person skilled in the art understands a single panel 102 in a spherical shape can also be selected depending on the need. Panels 102 provide a material made of soft plastic and thin walled material, such as poly-vinyl chloride resin, for example. In accordance with the present invention, panels 102 are made of a transparent material. Each panel 102 is curved such that when panels 12 attach, they form an inflatable ball such as a beach ball, for example as shown in FIGS. 9 and 10.

Each panel 102 includes first side 104 and second side 106. First side 104 indicates an outer side of panel 102 and second side 106 indicates an inner side of panel 102. Apparatus 100 includes strips 108. Strips 108 provide a material made of paper, plastic or any other suitable material. Further, strips 108 provide an opaque material and obscure view through them. In one example, strips 108 come in a rectangular configuration. In one example, strips 108 attach to panel 102 at first side 104. In another example, strips 108 attach to panel 102 at second side 106. Strips 108 attach to panel 102 using adhesive or fuse seams or stitches or any other known mechanism. Here, strips 108 attach at equal distance from one another, as seen in at least FIGS. 9 and 10. When attached to panel 102, strips 108 obscure the view of the user from first side 104 (FIG. 4). At second side 106, each strip 108 includes a still image 110, as shown in FIGS. 9 and 10. As such, panels 102 at its inner side i.e., second side 106 include a series of images 110 disposed at strips 108, in which each image 110 positions incrementally relative to the last image 110 in any given direction. In other words, strips 108 include a series of graduated images 110 i.e., adjacent images 110 that differ slightly and progressively from one to the next.

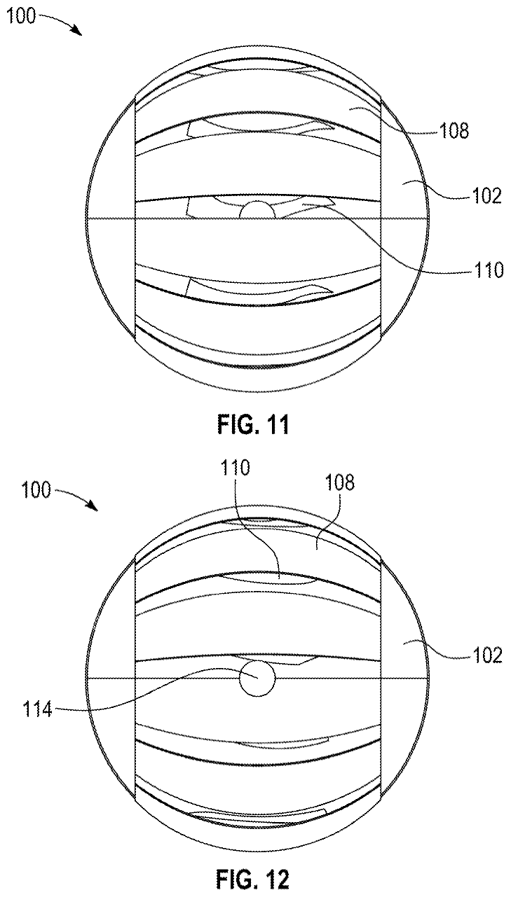

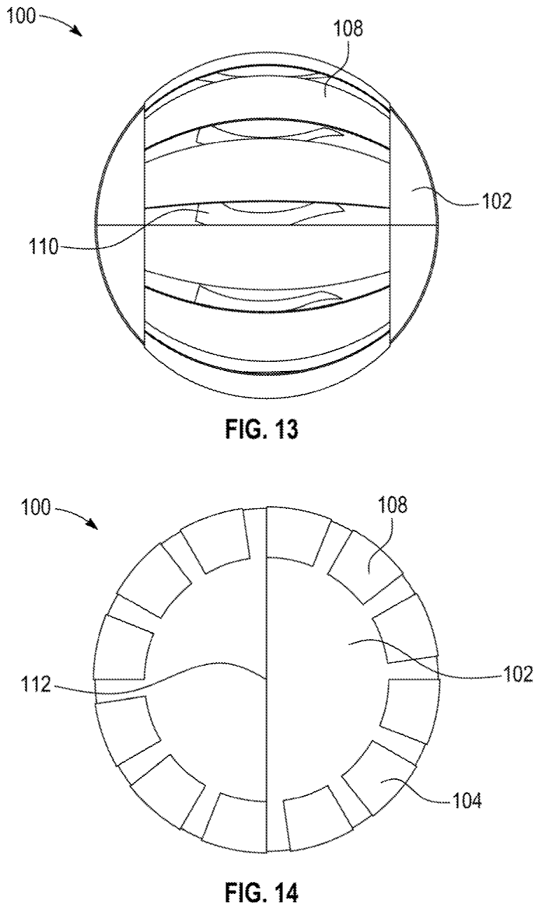

FIGS. 11 and 12 show side views of apparatus 100. Further, FIGS. 13 and 14 show a front and a top view, respectively of apparatus 100. Apparatus 100 includes valve 114 at any one panel 102 or at the center 114. Valve 114 allows to inflate apparatus 100 (ball) using a mouth or a pump as known in the art. FIGS. 10 and 12 show the feature of valve 114, in accordance with one exemplary embodiment of the present invention. When inflated, panels 102 form an inflatable ball that is leak-proof or airtight and provide a ball that rolls easily along a smooth surface.

Referring now to FIGS. 9, 10, 11, 12 and 13, operational features of apparatus 100 are explained. As specified above, panels 102 form an inflatable ball. The user inflates apparatus 100 (i.e., inflatable ball) by blowing the air through the mouth or using a pump. Once inflated, apparatus 100 gives a soft, and bouncy feel. The transparent panels 102 and strips 108 present a zoetrope. Specifically, transparent panels 102 act as viewing slits/slots allowing the user to view second side 106 (interior surface of panel). Strips 108 act as segments that obscure the view of the user into second side 106 (interior surface of panel). In other words, panels 102 act as an outer wall of the zoetrope in which strips 108 form a series of segments obscuring the inside view while the gap between strips 108 due to transparency of panels 102 form see-through/viewing slits of the zoetrope.

The user rotates apparatus 100 and looks at images 110 on strips 108 at second side 106 through transparent panels 102 acting as viewing slits from first side 104. Here, the user views images 110 alternatively through transparent panels 102 and then gets obscured by strips 108 between consecutive transparent panels 102. When apparatus 100 rotates or spins at an appropriate speed, images 110 are revealed and obscured in rapid succession to the user thereby creating the perception of an animation of images 110 to the user.

The presently disclosed apparatus can be used as a beach ball for playing beach and water games. At the time of playing, the apparatus presents a visual appeal with changing images to the users. Further, the apparatus can be used a zoetrope when it is not used for playing beach and water games. In one example, the presently disclosed apparatus can be used as a balloon, which the children can use to play. The balloon provides a material made of flexible material that is inflatable with a gas, such as helium, hydrogen, nitrous oxide, oxygen, and air. In another example, the presently disclosed apparatus can be made using large panels such that the apparatus can be placed at the entrance of amusement parks such as Disneyland™. In this example, the guests in the amusement parks can rotate and create the perception of an animation of the images. In another example, the presently disclosed apparatus can be made in suitable size for placing in hotels, schools, etc. as a decorative piece or entertainment device for occupants.

Although the drawings illustrate the slits in vertical configuration with respect to the ground or horizontal axis of the rotation of the apparatus, it is possible to provide a series of other slits in any given axis. Here, the apparatus includes more than one series of slits that may overlap. For example, one series of images may position vertically from the ground (similar to FIG. 1) and another series of images may position horizontally from the ground (where some of the slits overlap with vertical slits). In another example, one series of images may position vertically from the ground (similar to FIG. 1) and another series of images may position at 45 degrees from the ground and extend around the entire circumference of the apparatus (where some of the slits overlap with vertical slits). In the above examples, the user rotates the apparatus at a horizontal axis corresponding to a particular series of slits to view an animation of images. Further, the user bends his head or changes the direction of his viewing to view through another series of slits at a different horizontal axis to view different animation of images. A person skilled in the art understands that the perception of an animation of the images depends on the viewing angle of the user and axis in which the apparatus rotates. Above exemplary embodiment presents a single apparatus capable of providing multiple animations of the images when viewed through different axes.

Although the above description is presented to provide an inflatable ball integrating a zoetrope, it is possible to incorporate the features of the present invention in any object that has transparent walls/panels. As such, in one alternate implementation, the presently disclosed apparatus includes a bottle such as a beverage bottle. The bottle includes a panel that is a body of the bottle. The panel/body of the bottle is made of a transparent material. The body is imprinted or covered with a label having similar strips that obscure the view into the interior of the bottle. The inner side of the strips includes images as explained above. The transparent bottle body and the strips present a zoetrope allowing a view into the interior of the bottle, where changing illustrations are imprinted. Upon rotating, the bottle allows for viewing through the slits of the changing illustrations, creating the illusion of animated motion.

Based on the above, it is evident that the presently disclosed apparatus integrates a zoetrope and provides an animated image for the user.

A person skilled in the art appreciates that the apparatus may come in a variety of sizes depending on the need and comfort of the user. Further, different materials in addition to or instead of materials described herein may also be used and such implementations may be construed to be within the scope of the present subject matter. Further, many changes in the design and placement of components may take place without deviating from the scope of the presently disclosed apparatus.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

What is claimed is:

1. An apparatus integrating a zoetrope, the apparatus comprising:
a panel made of a transparent material; and
strips attached to said panel, wherein said strips attach to said panel at equal distance from one another, wherein said strips are made of an opaque material, wherein said strips comprise a series of graduated images at the inner side of said panel, and wherein the series of images differ slightly and progressively from one to the next,
wherein said transparent panel and said strips present a zoetrope in which said transparent panel acts as slits allowing a user to view the images on said strips at the inner side of said panel, and said strips act as a series of segments obscuring the view of the inner side of said panel, and
wherein the user rotates said panel at an appropriate speed to view the images alternatively through said transparent panel and obscure the images by said strips in rapid succession creating the perception of an animation of the images.

2. The apparatus of claim 1, wherein said panel comprises an inflatable ball.

3. The apparatus of claim 2, further comprises a valve for inflating said inflatable ball.

4. The apparatus of claim 1, wherein said panel comprises two or more panels, each having the same shape and size, and wherein said two or more panels take the shape of an inflatable ball.

5. The apparatus of claim 1, wherein said panel comprises a bottle.

6. The apparatus of claim 5, wherein said bottle comes in a cylindrical configuration.

7. The apparatus of claim 1, wherein said strips are made using one of a paper and a plastic material.

8. The apparatus of claim 1, wherein said strips imprint onto said panel.

9. The apparatus of claim 1, wherein said strips attach to said panel using one of adhesive and fuse seams.

10. The apparatus of claim 1, wherein said wherein said panel comprises an inflatable balloon.

11. A method of providing an apparatus integrating a zoetrope, said method comprising steps of:
providing a panel made of a transparent material;
attaching strips to said panel at equal distance from one another, the strips made of an opaque material;
providing a series of graduated images on said strips at the inner side of said panel, the series of images differing slightly and progressively from one to the next;
presenting a zoetrope with said transparent panel and said strips, said transparent panel acting as slits allowing a user to view the images on the strips at the inner side of said panel, and said strips acting as a series of segments obscuring the view of the inner side of said panels; and
rotating said panel at an appropriate speed for viewing the images alternatively through said transparent panel and obscuring the images by said strips in rapid succession creating the perception of an animation of the images.

12. The method of claim 11, further comprising providing an inflatable ball as said panel.

13. The method of claim 12, further comprising providing a valve for inflating the inflatable ball.

14. The method of claim 11, comprising attaching said strips to said panel using one of adhesive and fuse seams.

15. The method of claim 11, further comprising imprinting said strips onto said panel.

16. An apparatus integrating a zoetrope, the apparatus comprising:
panels made of a transparent material, wherein the panels attach and take the shape of an inflatable ball; and
strips attached to said panels, wherein said strips attach to said panels at equal distance from one another, wherein said strips are made of an opaque material, wherein said strips comprise a series of graduated images at the inner side of said panels, and wherein the series of images differ slightly and progressively from one to the next,
wherein said transparent panels and said strips present a zoetrope in which said transparent panels act as slits allowing a user to view the images on the strips at the inner side of said panels, and said strips act as a series of segments obscuring the view of the inner side of said panels, and
wherein the user rotates said panel at an appropriate speed to view the images alternatively through said transparent panels and obscure the images by said strips in rapid succession creating the perception of an animation of the images.

17. The apparatus of claim 16, wherein said panels comprise two or more panels, each having the same shape and size.

18. The apparatus of claim 16, further comprises a valve for inflating said inflatable ball.

19. The apparatus of claim 16, wherein said strips are made using one of a paper and a plastic material.

20. The apparatus of claim 16, wherein said strips imprint onto said panels.

21. The apparatus of claim 16, wherein said strips attach to said panels using one of adhesive and fuse seams.

22. The apparatus of claim 16, wherein said wherein said panels comprise two or more panels of an inflatable balloon.
